(19) United States
(12) Patent Application Publication
(10) Pub. No.: US 2026/0230456 A1
(43) Pub. Date: Aug. 6, 2026

(54) FAULT DIAGNOSIS METHOD FOR SECURE TRANSMISSION OF INDUSTRIAL DATA BASED ON TRANSFER LEARNING

(71) Applicants: Wuxi Vocational College of Science and Technology, Wuxi (CN); Xi'an Jiaotong University, Xi'an (CN)

(72) Inventors: Hongyan JIANG, Xi'an (CN); Dianjun FANG, Xi'an (CN); Ziyang YAO, Xi'an (CN); Feng CHENG, Wuxi (CN); Yanan SUN, Wuxi (CN); Hua CHEN, Wuxi (CN)

(21) Appl. No.: 19/632,152

(22) Filed: Mar. 27, 2026

(30) Foreign Application Priority Data
Apr. 23, 2025 (CN) 202510512274.7

(51) Int. Cl. H04L 9/40; G06F 11/07

(52) U.S. Cl. CPC H04L 63/0428; G06F 11/0709; G06F 11/079

(57) ABSTRACT

The present disclosure discloses a fault diagnosis method for secure transmission of industrial data based on transfer learning, belonging to the field of data supervision technology. The method includes: implementing secure supervision and diagnosis of industrial data by constructing a transfer learning model, adopting an end-to-end feature learning strategy, integrating CBAM hybrid attention module, dynamically enhancing fault sensitive features through channel and spatial attention mechanisms, and suppressing noise interference. By utilizing multi-scale parallel processing and residual skip connections, a limitation of limited feature coverage in traditional single scale networks has been overcome, while also alleviating a problem of gradient vanishing in deep networks. A combination of channel and spatial attention mechanisms with multi-scale feature extraction enables the network to dynamically enhance fault sensitive features, significantly improving robustness and accuracy of fault diagnosis.

### TECHNICAL FIELD

The present disclosure provides a fault diagnosis method for secure transmission of industrial data based on transfer learning, belonging to the field of data supervision technology.

### BACKGROUND

With a rapid development of industrial Internet, complexity of industrial systems and diversity of equipment are increasing, an amount of data is growing exponentially, and failure modes are becoming more complex and diversified. Due to technological limitations, existing fault diagnosis methods often rely on a single data source or fixed model, making it difficult to adapt to dynamic industrial environments and effectively handle complex fault scenarios with multi-source heterogeneous data and high real-time requirements. This makes traditional fault diagnosis methods gradually exposed the problems of low diagnosis efficiency, high misjudgment rate and insufficient adaptability to new fault modes when facing a growing demand for fault classification. It is difficult to meet an urgent demand for efficient, accurate and real-time fault diagnosis under the modern industrial Internet environment.

The current fault diagnosis classification methods include knowledge-based methods, model-based methods, deep learning based methods, and signal processing based methods. The knowledge-based method utilizes the experience accumulated by experts in long-term practice to establish a knowledge base and achieve fault diagnosis through a knowledge base. However, a coverage of the knowledge base is limited and heavily relies on the experience of experts, resulting in poor accuracy and low diagnostic efficiency. The model-based approach is to establish an accurate mathematical model and use residual between a model prediction and actual measurement data to detect faults. However, this method requires high accuracy of the accurate mathematical model and cannot adapt to dynamic randomness and multi-source uncertainty of complex systems. The method based on deep learning learns features of input data layer by layer using a multi hidden layer network, and forms high-level representations through multi-level abstraction to achieve fault classification. However, this method requires high quality and quantity of training data, and a structure of the multi hidden layer network is complex, resulting in poor real-time diagnosis. The signal processing based method extracts characteristics of faults through signal processing techniques and classifies them based on statistical analysis. However, this method is sensitive to signal noise, has poor anti-interference ability, and diagnostic results depend on an accuracy of signal processing. In addition, existing fault diagnosis methods fail to ensure a security of data transmission, which may result in data leakage during a transmission process and affect final diagnosis results.

Therefore, with a rapid increase in data volume and a complexity of network environments, how to ensure security and effectiveness of industrial data transmission while achieving accurate fault diagnosis of industrial equipment has become a core challenge in improving an intelligence level of industrial equipment.

### SUMMARY

In order to solve the mentioned problems in the existing technology, the present disclosure proposes a fault diagnosis method for secure transmission of industrial data based on transfer learning. The technical solution adopted includes:
s1: collecting raw data from different sources in industrial processes and classifying different types of data into different levels based on importance of the raw data;
s2: constructing a data storage module by defining an ontology model and mapping the raw data from s1 to the ontology model to obtain mapped data;
s3: preprocessing the mapped data in s2 to obtain preprocessed data;
s4: encrypting and transmitting the preprocessed data in s3 to obtain encrypted transmission data;
s5: constructing a transfer learning model and inputting the encrypted transmission data in s4 into the transfer learning model for training to obtain a trained transfer learning model; and;
s6: using the trained transfer learning model obtained in s5 to achieve fault diagnosis under secure transmission conditions of industrial data.

In some embodiments, in s1, the raw data is classified and graded according to the “Guidelines for Industrial Data Classification and Grading”, including research and development, production, operation and maintenance, management, and external data domains. At the same time, the raw data is classified into different levels based on its potential impact;
in some embodiments, a classification of data levels in s1 is: data can be divided into three levels based on the potential impact,
where a leakage or failure of third level data may cause serious security accidents, major environmental incidents, or significant economic losses;
a leakage or failure of secondary level data issues may lead to security incidents or cascading effects, having a significant impact on enterprise operations, and may result in a leakage of supplier or customer resources;
an impact of a leakage or failure of primary level data on production operations is limited, with low recovery costs and controllable negative effects.

In some embodiments, s2 includes:
s21: defining an ontology model. In the present step, the ontology model is described using Web Ontology Language (OWL) to define concepts such as devices and operations, and semantics of the data are represented in RDF format. Each element in a data model is identified by a unique Uniform Resource Identifier (URI) and saved as a read-only file in Extensible Markup Language (XML) format. Definitions ensure semantic consistency in subsequent data storage and querying, making data management more standardized.
s22: designing an original database. The present stage is a design and construction of relational databases, typically used to store raw data that has not been semantically processed. Designing tables (such as equipment tables, diagnostic tables, etc.) and defining appropriate columns for each table (such as equipment ID, equipment type, fault type). The data is stored in a standard table structure without involving complex semantic associations, and is managed in a traditional way.
s23: using D2RQ tool to map database to an ontology. In the present step, the D2RQ tool is used to map the standard table structure and the raw data from the original database to the defined ontology model. Each database table is mapped to an entity in the ontology, column names are mapped to attributes of an entity, and each row of data in the database corresponds to an instance in the ontology. This mapping enables semantic management of relational data through the ontology model, supporting subsequent semantic queries.

In some embodiments, s3 involves data cleaning and formatting to remove noise, missing values, and outliers from the raw data, ensuring an accuracy and completeness of the data. At the same time, converting data from different sources and formats into a unified standard format to ensure data consistency and availability. This process can improve data quality and provide a reliable foundation for subsequent analysis and fault diagnosis; s3 specifically includes:
s31: data cleaning; processing noise in data through wavelet transform or Fourier transform, in order to identify and remove irrelevant or randomly erroneous data; filling missing values through interpolation, deletion, and other methods; identifying outliers that deviate significantly from a mean or distribution using Z-score or IQR methods, and combining with abrupt changes or abnormal fluctuations in time-series data to identify and correct extreme values or erroneous readings in the data.
s32: data formatting processing; a process of converting data from different sources into a unified standard format through data standardization or normalization. Data from different sources may use different timestamps, units, or field names, so a unified transformation is needed to ensure that the data is compatible with each other and there will be no conflicts in subsequent processing.
s33: data conversion involves converting data from one format to another, such as converting Comma-Separated Values (CSV) files to database tables, to ensure compatibility between different systems.

In some embodiments, s4 includes:
s41: developing security policies and encrypting data. Developing appropriate security policies based on data types and application scenarios, and using Data Encryption Standard (DES) encryption technology to protect data confidentiality and prevent interception during transmission;
firstly, generating a sub key, performing key permutation on 64 bit keys without considering the 8th bit of each byte, reducing a DES key from 64 bit to 56 bit, and divide the 56 bit key into two parts, where the first 28 bits being C₀ and the last 28 bits being D₀, where an expression is:

$$\begin{matrix}{C}_{0} = {K}_{57} {K}_{49} … {K}_{52} {K}_{44} {K}_{36} \\ {D}_{0} = {K}_{63} {K}_{55} … {K}_{20} {K}_{12} {K}_{4}\end{matrix}$$

then, C_{A} undergo cyclic left shifts of 1 bits and D_{A} undergo cyclic left shifts of 2 bits based on a number of rounds A (integer values [1,16]) for a total of 16 cyclic shifts. The resulting C_{A} and D_{A} undergo cyclic left shifts and are then compressed and replaced to obtain the sub key K.

After generating the sub key, a DES algorithm first performs initial permutation on a 64 bit input data. Next, defining first 32 bits of the data as a left half data and last 32 bits as a right half data, and enter 16 rounds of iteration. In each round, the right half data is first subjected to expansion permutation, then exclusive or (XOR) operating with the sub key of the current round, and then processed using an encryption function F to generate a 32-bit output. The 32-bit output is XOR operated and swapped with the left half data as input for the next round. After 16 rounds of processing, the left half data and right half data are merged and subjected to inverse initial permutation to obtain a ciphertext output M, where an expression is:

$$M = {D}_{1} {D}_{2} … {D}_{63} {D}_{64}$$

a decryption process involves swapping a positions of an initial transposition table and a final transposition table, using a sub key K₁₆ for the first time, and using K₁₅ for the second time, and so on for 16 times to obtain a decrypted ciphertext.
s42: implementing secure transmission protocols (such as Secure Sockets Layer/Transport Layer Security (SSL/TLS)) through an Industrial Data Space (IDS) framework, establishing encrypted channels, and preventing data tampering or eavesdropping. Finally, the IDS framework ensures that cross organizational data exchange complies with privacy protection and compliance requirements, supporting secure data sharing and interoperability;
the IDS framework provides standardized connectivity and usage control for a data security supervision platform through the first data connector (First Data Connector) and second data connector (Second Data Connector), allowing executing trusted applications in isolated and authenticated environments. An application store (APP Store) in the data security supervision platform has functions such as basic data provision, data service and management, vocabulary management, and software monitoring, and these applications can be certified by IDS accredited certification agencies. A broker (Broker) is responsible for providing management, search, data exchange protocols, and data exchange monitoring functions for data sources. A data provider (Data Provider) can control an access and use of data by data consumers (Data Consumers), allowing the consumers to access data for specific purposes and models. Data consumers can search for data from different data providers through brokers and use their data after establishing secure protocols with the data providers. A data sink (Data Sink) is responsible for receiving data from the data source and converting it into a format suitable for further processing.
s43: clearly defining a data scope, signing security protocols, and evaluating security capabilities of recipient. The data provider should clearly defining the scope, category, conditions, and processing procedures of the data, and signing data security protocols with the recipient to ensure that both parties have clear agreements on use, security requirements, and responsibilities of the data. In the data security protocols, the data provider also needs to evaluate data security protection capabilities of recipient to ensure that they have sufficient technology and measures to protect the security of the data;
s44: using DES encryption technology to encrypt data during transmission, ensuring that the data will not be intercepted or tampered with, and then ensuring a confidentiality and integrity of the data;
s45: building a standardized framework for data exchange through the IDS framework, allowing data providers to maintain control over the data, ensuring secure sharing of data across organizations and across platforms, while complying with privacy protection and compliance requirements;
s46: designing access control and permission management. Data providers need to establish strict access control policies to ensure that only authorized users can access and use sensitive data, and prevent unauthorized access through authentication and permission management.

In some embodiments, the transfer learning model in s5 includes: feature extraction module, domain adaptation module, and diagnostic classification module;
feature extraction module in the transfer learning model adopts a multi-scale residual neural network combined with attention mechanism. The network adopts an end-to-end feature learning strategy, and the source domain data and target domain data are preprocessed through two levels of enhanced basic convolutional layers. Each level adopts a “Conv-BN-ReLU Pool” standardized structure: the first level maps single channel data to a 32 dimensional feature space through a 1×7 convolution kernel, and the second level is extended to 64 channels, enhancing feature expression ability through batch normalization and nonlinear activation. Inputting preprocessed 64 channel features into the multi-scale residual neural network, where the multi-scale residual neural net consists of three parallel multi-scale feature extraction units, and three different sizes of convolution kernels, 3, 5, and 7, are used to construct heterogeneous receptive fields and to synchronously capture local details and global trend features of fault data. Each unit is embedded with a two-level residual structure, where a first level maps 64 channels to 64 channels, the second level is extended to 128 channels, and integrates Convolutional Block Attention Module (CBAM) hybrid attention module to dynamically enhance fault sensitive features through channel and spatial attention mechanisms and then suppress noise interference. An output of each unit form a 384 dimensional feature tensor through an across channels concatenation, and is compressed into a 256 dimensional high-density representation through 1×3 fusion convolution. Finally, a 256 dimensional global feature vector is generated through global average pooling, and fault classification is achieved through a fully connected layer.

Specifically includes:
s51: the feature extraction module extracts features through a multi-scale residual neural network combined with attention mechanism;

extracting basic features is passed the encrypted transmission data through a 1×7 convolutional layer and a 2×2 max pooling layer. The basic features are input into the three multi-scale convolutional sub blocks for processing. Each multi-scale convolutional sub block contains two cascaded residual blocks, where a size of the convolution kernel of a first multi-scale convolutional sub block is 1×3, a size of convolutional kernel of a second multi-scale convolutional sub block is 1×5, and a size of convolutional kernel of a third multi-scale convolutional sub block is 1×7. In each multi-scale convolutional sub block, a number of input channels in first residual block is 64, a number of output channels in first residual block is 64; a number of input channels in second residual block is 64, and a number of output channels in second residual block is 128. The basic features are weighted using the CBAM hybrid attention mechanism. A number of feature-output channels for each multi-scale convolutional sub block is 128. An output of each unit form a 384 dimensional feature tensor through an across channels, and is compressed into a 256 dimensional high-density representation through 1×3 fusion convolution. A final feature map is input to the fully connected layer and processed to output the classification result.
s52: domain adaptation, constructing an improved measurement difference module that combines the joint maximum mean difference Joint Maximum Mean Discrepancy (JMMD) and correlation alignment Correlation Alignment (CORAL) to collaboratively aligning cross domain feature distributions at both global and local levels, effectively reducing inter domain differences and improving a classification accuracy of unlabeled samples in the target domain;
the joint maximum mean difference adjusts global statistical characteristics and local feature relationships of source and target domains through jointly matching edge distributions and conditional distributions; where an expression is:

$${JMMD}^{2} ( {D}_{s} , {D}_{t} ) = {‖ {E}_{{x}_{s} ∼ {D}_{s}} [ k ( {x}_{s} , \cdot ) ] - {E}_{{x}_{t} ∼ {D}_{t}} [ k ( {x}_{t} , \cdot ) ] ‖}_{ℋ}^{2}$$

where, Dₛ is a data distribution of a source domain, which represents a distribution of labeled data used during model training; Dₜ is a data distribution of target domain, which represents a distribution of unlabeled data that the transfer learning model needs to adapt to; Eₓ_{ₛ}_{~D}_{ₛ} is an expectation of all samples xₛ in Dₛ, that is, a statistical average of the source domain data; Eₓ_{ₜ}_{~D}_{ₜ} is an expectation of all samples xₜ in Dₜ, that is, a statistical average of the target domain data; ∥·∥ is a norm; k(xₛ,·) is a kernel function; [symbol] is a reproducing kernel Hilbert space of the kernel (RKHS).

The correlation alignment is achieved by aligning a covariance matrices of features of the source domain and a covariance matrices of features of the target domain, where then reducing distribution difference between source domain and target domain. Assuming that a data feature of the source domain is X_{S}∈Rⁿ^{ₛ}^{×d} and a data feature of the target domain is Xₜ∈Rⁿ^{ₜ}^{×d}, an interdomain alignment is achieved by minimizing a difference between the covariance matrix of the source domain and the covariance matrix of the target domain, where an expression is:

$$CORAL ( {X}_{S} , {X}_{t} ) = {‖ Cov ( {X}_{s} ) - Cov ( {X}_{t} ) ‖}_{F}^{2}$$

where, Cov(Xₛ) is the covariance matrix of the source domain; Cov(Xₜ) is the covariance matrix of the target domain; and ∥·∥_{F} is a Frobenius norm, used for measuring difference between covariance matrices.

Introducing a correlation alignment method based on the joint maximum mean difference, further reducing local distribution differences between the source domain and the target domain through covariance matrices alignment. The joint maximum mean difference adopts a kernel mean embedding method to compare feature distributions of the source domain and the target domain as a whole, and jointly match edge distribution and conditional distribution to adjust global statistical characteristics of the entire feature space. In contrast, correlation alignment aligns the covariance matrices to make the internal correlations of features in different domains more consistent, emphasizing a matching of local feature relationships.
s53: constructing a total loss function for performing reverse updating on the transfer learning model, wherein a joint maximum mean difference loss function, a correlation alignment loss function, and a source domain classification loss function jointly form the total loss function;
an expression for the joint maximum mean difference loss function in s53 is:

$${L}_{JMMD} = \frac{1}{{n}_{s}^{2}} {\sum }_{i , j = 1}^{{n}_{s}} k ( {x}_{s}^{i} , {x}_{s}^{j} ) + \frac{1}{{n}_{t}^{2}} {\sum }_{i , j = 1}^{{n}_{t}} k ( {x}_{t}^{i} , {x}_{t}^{j} ) - \frac{2}{{n}_{s} {n}_{t}} {\sum }_{i = 1}^{{n}_{s}} {\sum }_{j = 1}^{{n}_{t}} k ( {x}_{s}^{i} , {x}_{t}^{j} )$$

where, k is a kernel function, used to measure a similarity between two samples; nₛ is a number of samples in the source domain, that is a total number of samples extracted from D_{S};

$${x}_{s}^{i} and {x}_{s}^{j}$$

are sample pairs in the source domain, where

$${x}_{s}^{i}$$

is an i-th sample in the source domain,

$${x}_{s}^{j}$$

is a j-th sample in the source domain, where i, j∈{1, 2, . . . , nₛ}; nₜ is a number of samples in the target domain,

$${x}_{t}^{i} and {x}_{t}^{j}$$

are sample pairs in the target domain, where

$${x}_{t}^{i}$$

is an i-th sample in the target domain,

$${x}_{t}^{j}$$

is a j-th sample in the target domain, where i, j∈{1, 2, . . . , nₜ}.

An expression for the correlation alignment loss function is:

$${L}_{CORAL} = \frac{1}{{d}^{2}} {‖ Cov ( {X}_{S} ) - Cov ( {X}_{t} ) ‖}_{F}^{2}$$

where, d is a dimension of feature space; Cov(Xₛ) is the covariance matrix of the source domain; Cov(Xₜ) is the covariance matrix of the target domain; and ∥·∥_{F} is the Frobenius norm, used to measure difference between covariance matrices. Correlation alignment can align the covariance matrices of the source and target domains, making their internal correlations more consistent through minimizing the loss function.

An expression for the total loss function is:

$${L}_{total} = {L}_{CE} + {λ}_{JMMD} {L}_{JMMD} + {λ}_{CORAL} {L}_{CORAL}$$

where, L_{JMMD} is a JMMD loss between the source domain and the target domain; L_{CORAL} is a CORAL loss between the source domain and the target domain; L_{CE} is a cross entropy loss in source domain classification, wherein an expression of L_{CE} is:

$${L}_{CE} = - \frac{1}{n} {\sum }_{i = 1}^{{n}_{s}} {\sum }_{c = 1}^{C} {y}_{s}^{( i , c )} log ( {\hat{y}}_{s}^{( i , c )} )$$

where, λ_{JMMD} is a hyper-parameter used to adjust weights of each loss items in the joint maximum mean difference, λ_{CORAL} is a hyper-parameter used to adjust weights of each loss items in the correlation alignment, nₛ is a number of samples in the source domain, C is a total number of classification categories.

$${y}_{s}^{( i , c )}$$

is a true label or the i-th sample in the source domain on class c, which is usually represented by one hot encoding; and

$${\hat{y}}_{s}^{( i , c )}$$

is a prediction probability or the i-th sample in the source domain on class c by the transfer learning model, which is usually output by an softmax function;
therefore, an expression for the total loss function is:

$${L}_{total} = - \frac{1}{{n}_{s}} {\sum }_{i = 1}^{{n}_{s}} {\sum }_{c = 1}^{C} {y}_{s}^{( i , c )} log ( {\hat{y}}_{s}^{( i , c )} ) + {L}_{JMMD} {‖ {E}_{{x}_{s} ∼ {D}_{s}} [ k ( {x}_{s} , \cdot ) ] - {E}_{{x}_{t} ∼ {D}_{t}} [ k ( {x}_{t} , \cdot ) ] ‖}_{ℋ}^{2} + {λ}_{CORAL} {‖ Cov ( {X}_{S} ) - Cov ( {X}_{t} ) ‖}_{F}^{2}$$

an optimization process of the total loss function will simultaneously consider source domain classification task and distribution alignment between the source domain and the target domain, then achieving better cross domain transfer learning and classification performance.
s6: using the transfer learning model obtained in s5 to achieve fault diagnosis under secure transmission conditions of industrial data;
inputting the preprocessed data into the transfer learning model through the transmission method in s4 to achieve secure supervision and fault diagnosis of industrial data.

The beneficial effects of the present disclosure are:
the present disclosure proposes a fault diagnosis method for secure transmission of industrial data based on transfer learning, which achieves security supervision and diagnosis of industrial data by constructing a transfer learning model. Adopting an end-to-end feature learning strategy, integrating CBAM hybrid attention module, dynamically strengthens fault sensitive features through channel and spatial attention mechanisms, and suppresses noise interference. A limitation of limited feature coverage in traditional single scale networks has been overcome through utilizing multi-scale parallel processing and residual skip connections, while also alleviating a problem of gradient vanishing in deep networks. A combination of channel and spatial dual attention mechanism and multi-scale feature extraction enables the network to dynamically enhance fault sensitive features, significantly improving robustness and accuracy of fault diagnosis. In addition, difference between the source domain and the target domain is reduced by combining the joint maximum mean difference and correlation alignment to ensure the effectiveness of cross domain transfer learning.

### BRIEF DESCRIPTION OF THE DRAWINGS

In order to provide a clearer explanation of the technical solution in the embodiments of the present disclosure, a brief introduction will be given to drawings required for the description of the embodiments. It is obvious that the drawings described below are only some embodiments of the present disclosure. For those skilled in the art, other drawings can be obtained based on these drawings without creative labor.

FIG. 1 shows a flowchart of the fault diagnosis method for secure transmission of industrial data based on transfer learning by the present disclosure.

FIG. 2 shows a schematic diagram of the data mapping in the data storage module of the fault diagnosis method for secure transmission of industrial data based on transfer learning proposed by the present disclosure.

FIG. 3 shows a schematic diagram of the DES encryption technology in the data storage module of the fault diagnosis method for secure transmission of industrial data based on transfer learning proposed by the present disclosure.

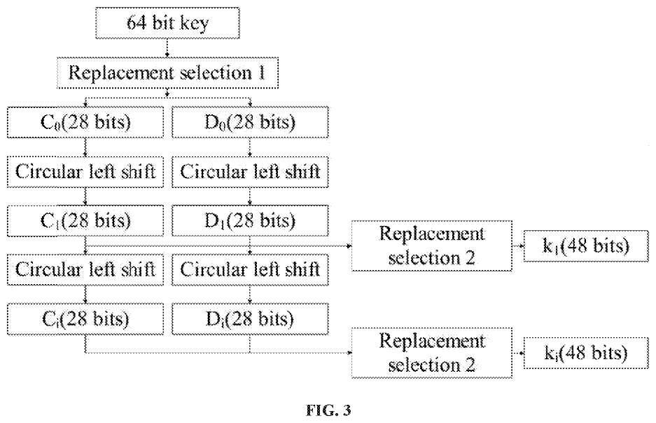

FIG. 4 shows an IDS component diagram in the data storage module of the fault diagnosis method for secure transmission of industrial data based on transfer learning proposed by the present disclosure.

FIG. 5 shows a schematic diagram of transfer learning model architecture of the fault diagnosis method for secure transmission of industrial data based on transfer learning proposed by the present disclosure.

FIG. 6 shows a matrix result chart of classification confusion of the fault diagnosis method for secure transmission of industrial data based on transfer learning proposed by the present disclosure.

FIG. 7 shows a scatter plot of classification results of the fault diagnosis method for secure transmission of industrial data based on transfer learning proposed by the present disclosure.

FIG. 8 shows a schematic diagram of structural parameters of multi-scale residual neural network combined with attention mechanism of the fault diagnosis method for secure transmission of industrial data based on transfer learning proposed by the present disclosure.

### DETAILED DESCRIPTION OF THE EMBODIMENTS

In order to clarify the purpose, technical solution, and advantages of the present disclosure, further detailed descriptions of the embodiments of the present disclosure will be provided below in conjunction with accompanying drawings.

### Embodiment 1

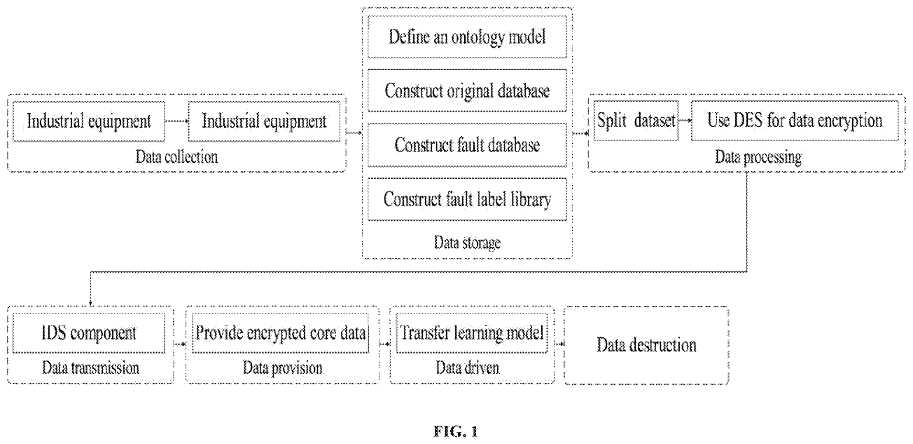

The present embodiment provides a fault diagnosis method for secure transmission of industrial data based on transfer learning, a flowchart of the method is shown in FIG. 1, where including:
s1: collecting raw data from different sources in industrial processes and classifying different types of data into different levels based on importance of the raw data;
s2: constructing a data storage module by defining an ontology model and mapping the raw data from s1 to the ontology model to obtain mapped data;
s3: preprocessing the mapped data in s2 to obtain preprocessed data;
s4: encrypting and transmitting the preprocessed data in s3 to obtain encrypted transmission data;
s5: constructing a transfer learning model and inputting the encrypted transmission data in s4 into the transfer learning model for training to obtain a trained transfer learning model; and;
s6: using the trained transfer learning model obtained in s5 to achieve fault diagnosis under secure transmission conditions of industrial data.

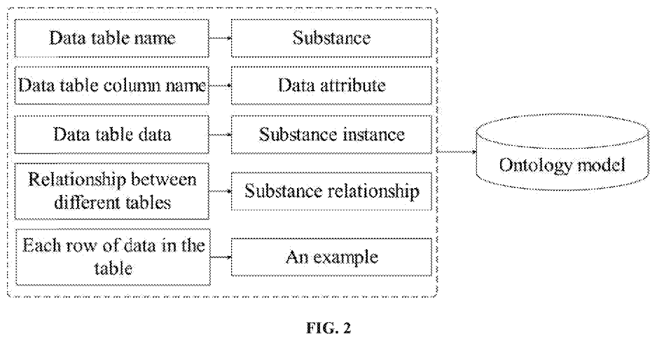

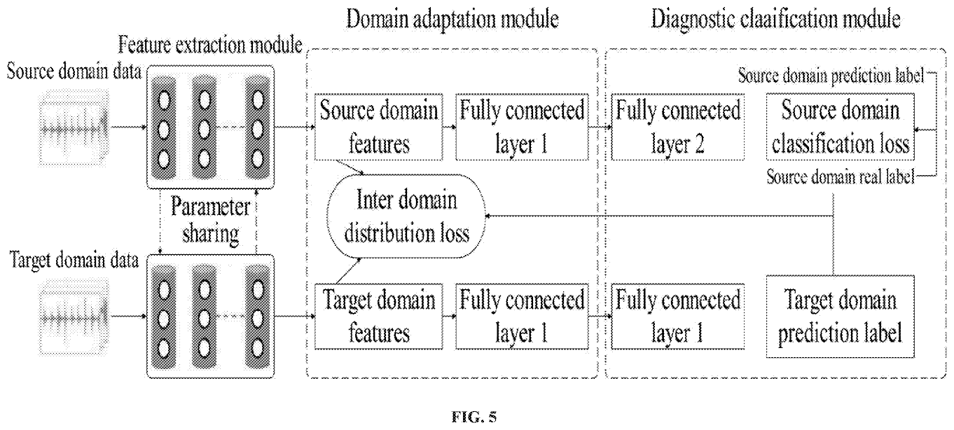

In s1, the raw data is classified and graded according to the “Guidelines for Industrial Data Classification and Grading”, including research and development, production, operation and maintenance, management, and external data domains. At the same time, the raw data is classified into different levels based on its potential impact;
a classification of data levels in s1 is: data can be divided into three levels based on the potential impact,
where a leakage or failure of third level data may cause serious security accidents, major environmental incidents, or significant economic losses;
a leakage or failure of secondary level data issues may lead to security incidents or cascading effects, having a significant impact on enterprise operations, and may result in a leakage of supplier or customer resources;
an impact of a leakage or failure of primary level data on production operations is limited, with low recovery costs and controllable negative effects.
s2 includes:
s21: defining an ontology model. In the present step, the ontology model is described using OWL to define concepts such as devices and operations, and semantics of the data are represented in RDF format. Each element in a data model is identified by a unique URI and saved as a read-only file in XML format. Definitions ensure semantic consistency in subsequent data storage and querying, making data management more standardized.
s22: designing an original database. The present stage is a design and construction of relational databases, typically used to store raw data that has not been semantically processed. Designing tables (such as equipment tables, diagnostic tables, etc.) and defining appropriate columns for each table (such as equipment ID, equipment type, fault type). The data is stored in a standard table structure without involving complex semantic associations, and is managed in a traditional way.
s23: using D2RQ tool to map database to an ontology. As shown in FIG. 2, in the present step, the D2RQ tool is used to map the standard table structure and the raw data from the original database to the defined ontology model. Each database table is mapped to an entity in the ontology, column names are mapped to attributes of an entity, and each row of data in the database corresponds to an instance in the ontology. This mapping enables semantic management of relational data through the ontology model, supporting subsequent semantic queries.
s3 involves data cleaning and formatting to remove noise, missing values, and outliers from the raw data, ensuring an accuracy and completeness of the data. At the same time, converting data from different sources and formats into a unified standard format to ensure data consistency and availability. This process can improve data quality and provide a reliable foundation for subsequent analysis and fault diagnosis; s3 specifically includes:
s31: data cleaning; processing noise in data through wavelet transform or Fourier transform, in order to identify and remove irrelevant or randomly erroneous data; filling missing values through interpolation, deletion, and other methods; identifying outliers that deviate significantly from a mean or distribution using Z-score or IQR methods, and combining with abrupt changes or abnormal fluctuations in time-series data to identify and correct extreme values or erroneous readings in the data
s32: data formatting processing; a process of converting data from different sources into a unified standard format through data standardization or normalization. Data from different sources may use different timestamps, units, or field names, so a unified transformation is needed to ensure that the data is compatible with each other and there will be no conflicts in subsequent processing.
s33: data conversion involves converting data from one format to another, such as converting CSV files to database tables, to ensure compatibility between different systems.
s4 includes:
s41: developing security policies and encrypting data. Developing appropriate security policies based on data types and application scenarios, and using DES encryption technology to protect data confidentiality and prevent interception during transmission;
as shown in FIG. 5, firstly generating a sub key, performing key permutation on 64 bit keys without considering the 8th bit of each byte, reducing a DES key from 64 bit to 56 bit, and divide the 56 bit key into two parts, where the first 28 bits being C₀ and the last 28 bits being D₀, where an expression is:

$${C}_{0} = {K}_{57} {K}_{49} …… {K}_{52} {K}_{44} {K}_{36}$$

$${D}_{0} = {K}_{63} {K}_{55} …… {K}_{20} {K}_{12} {K}_{4}$$

then, C_{A} undergo cyclic left shifts of 1 bits and D_{A} undergo cyclic left shifts of 2 bits based on a number of rounds A (integer values [1,16]) for a total of 16 cyclic shifts. The resulting C_{A} and D_{A} undergo cyclic left shifts and are then compressed and replaced to obtain the sub key K.

After generating the sub key, a DES algorithm first performs initial permutation on a 64 bit input data. Next, defining first 32 bits of the data as a left half data and last 32 bits as a right half data, and enter 16 rounds of iteration. In each round, the right half data is first subjected to expansion permutation, then exclusive or (XOR) operating with the sub key of the current round, and then processed using an encryption function F to generate a 32-bit output. The 32-bit output is XOR operated and swapped with the left half data as input for the next round. After 16 rounds of processing, the left half data and right half data are merged and subjected to inverse initial permutation to obtain a ciphertext output

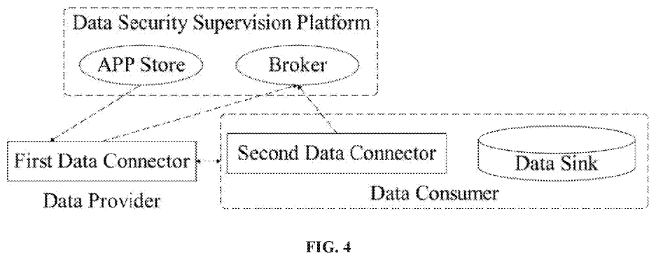

A decryption process involves swapping a positions of an initial transposition table and a final transposition table, using a sub key K₁₆ for the first time, and using K₁₅ for the second time, and so on for 16 times to obtain a decrypted ciphertext.
s42: implementing secure transmission protocols (such as SSL/TLS) through a IDS framework, establishing encrypted channels, and preventing data tampering or eavesdropping. Finally, the IDS framework ensures that cross organizational data exchange complies with privacy protection and compliance requirements, supporting secure data sharing and interoperability;
as shown in FIG. 4, the IDS framework provides standardized connectivity and usage control for a data security supervision platform through the first data connector and second data connector, allowing executing trusted applications in isolated and authenticated environments. The APP Store in the data security supervision platform has functions such as basic data provision, data service and management, vocabulary management, and software monitoring, and these applications can be certified by IDS accredited certification agencies. A broker is responsible for providing management, search, data exchange protocols, and data exchange monitoring functions for data sources. A data provider can control an access and use of data by data consumers, allowing the consumers to access data for specific purposes and models. Data consumers can search for data from different data providers through brokers and use their data after establishing secure protocols with the data providers. The data sink is responsible for receiving data from the data source and converting it into a format suitable for further processing.
s43: clearly defining a data scope, signing security protocols, and evaluating security capabilities of recipient. The Data provider should clearly defining the scope, category, conditions, and processing procedures of the data, and signing data security protocols with the recipient to ensure that both parties have clear agreements on use, security requirements, and responsibilities of the data. In the data security protocols, the data provider also needs to evaluate data security protection capabilities of recipient to ensure that they have sufficient technology and measures to protect the security of the data;
s44: using DES encryption technology to encrypt data during transmission, ensuring that the data will not be intercepted or tampered with, and then ensuring a confidentiality and integrity of the data’
s45: building a standardized framework for data exchange through the IDS framework, allowing data providers to maintain control over the data, ensuring secure sharing of data across organizations and across platforms, while complying with privacy protection and compliance requirements;
s46: designing access control and permission management. data providers need to establish strict access control policies to ensure that only authorized users can access and use sensitive data, and prevent unauthorized access through authentication and permission management.

In s5, constructing a transfer learning model, as shown in FIG. 5, where the transfer learning model includes: feature extraction module, domain adaptation module, and diagnostic classification module;
s51: the feature extraction module extracts features through a multi-scale residual neural network combined with attention mechanism;

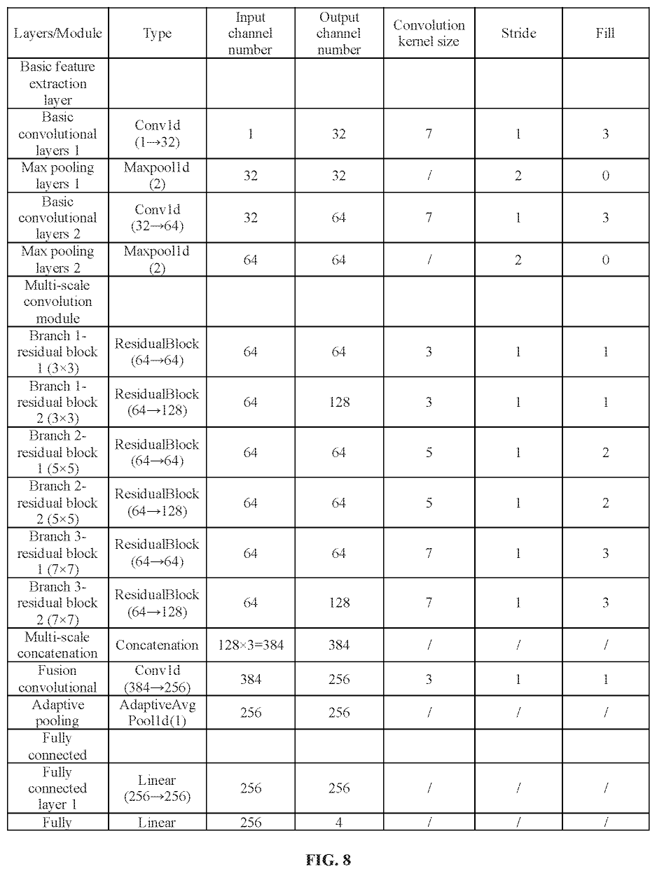

extracting basic features is passed by passing the encrypted transmission data through two layers of a 1×7 convolutional layer and a 2×2 max pooling layer. The basic features are input into the three multi-scale convolutional sub blocks for processing. Each multi-scale convolutional sub block contains two cascaded residual blocks, where a size of the convolution kernels of a first multi-scale convolutional sub block is 1×3, a size of convolutional kernel of a second multi-scale convolutional sub block is 1×5, and a size of convolutional kernel of a third multi-scale convolutional sub block is 1×7. In each multi-scale convolutional sub block, a number of input channels in first residual block is 64, a number of output channels in first residual block is 64; a number of input channels in second residual block is 64, and a number of output channels in second residual block is 128. The basic features are weighted using the CBAM hybrid attention mechanism. A number of feature-output channels for each multi-scale convolutional sub block is 128. An output of each unit form a 384 dimensional feature tensor through an across channels, and is compressed into a 256 dimensional high-density representation through 1×3 fusion convolution. A final feature map is input to the fully connected layer and processed to output the classification result. Specific structural parameters of multi-scale residual neural network combined with attention mechanism are shown in FIG. 8.
s52: domain adaptation, constructing an improved measurement difference module that combines the joint maximum mean difference JMMD and correlation alignment CORAL to collaboratively aligning cross domain feature distributions at both global and local levels, effectively reducing inter domain differences and improving a classification accuracy of unlabeled samples in the target domain;
the joint maximum mean difference adjusts global statistical characteristics and local feature relationships of source and target domains through jointly matching edge distributions and conditional distributions; where an expression is:

$${JMMD}^{2} ( {D}_{s} , {D}_{t} ) = {‖ {E}_{{x}_{s} ∼ {D}_{s}} [ k ( {x}_{s} , \cdot ) ] - {E}_{{x}_{t} ∼ {D}_{t}} [ k ( {x}_{t} , \cdot ) ] ‖}_{ℋ}^{2}$$

where, Dₛ is a data distribution of a source domain, which represents a distribution of labeled data used during model training; Dₜ is a data distribution of target domain, which represents a distribution of unlabeled data that the transfer learning model needs to adapt to; Eₓ_{ₛ}_{~D}_{ₛ} is an expectation of all samples xₛ in Dₛ, that is, a statistical average of the source domain data; Eₓ_{ₜ}_{~D}_{ₜ} is an expectation of all samples xₜ in Dₜ, that is, a statistical average of the target domain data; ∥·∥ is a norm; k(xₛ,·) is a kernel function; [symbol] is RKHS.

An expression for the joint maximum mean difference loss function in s53 is:

$${L}_{JMMD} = \frac{1}{{n}_{s}^{2}} {\sum }_{i , j = 1}^{{n}_{s}} k ( {x}_{s}^{i} , {x}_{s}^{j} ) + \frac{1}{{n}_{t}^{2}} {\sum }_{i , j = 1}^{{n}_{t}} k ( {x}_{t}^{i} , {x}_{t}^{j} ) - \frac{2}{{n}_{s} {n}_{t}} {\sum }_{i = 1}^{{n}_{s}} {\sum }_{j = 1}^{{n}_{t}} k ( {x}_{s}^{i} , {x}_{t}^{j} )$$

where, k is a kernel function, used to measure a similarity between two samples; nₛ is a number of samples in the source domain, that is a total number of samples extracted from the D_{S};

$${x}_{s}^{i} and {x}_{s}^{j}$$

are sample pairs in the source domain, where

$${x}_{s}^{i}$$

is an i-th sample in the source domain,

$${x}_{s}^{j}$$

is a j-th sample in the source domain, where i, j∈{1, 2, . . . , nₛ}; nₜ is a number of samples in the target domain,

$${x}_{t}^{i} and {x}_{t}^{j}$$

are sample pairs in the target domain, where

$${x}_{t}^{i}$$

is an i-th sample in the target domain,

$${x}_{t}^{j}$$

is a j-th sample in the target domain, where i, j∈{1, 2, . . . , nₜ}.

The correlation alignment is achieved by aligning a covariance matrices of the source domain and a covariance matrices of the target domain, where then reducing distribution difference between source domain and target domain. Assuming that a data feature of the source domain is Xₛ∈Rⁿ^{ₛ}^{×d} and a data feature of the target domain is Xₜ∈Rⁿ^{ₜ}^{×d}, an interdomain alignment is achieved by minimizing a difference between the covariance matrices of the source domain and the target domain, where an expression is:

$$CORAL ( {X}_{S} , {X}_{t} ) = {‖ Cov ( {X}_{s} ) - Cov ( {X}_{t} ) ‖}_{F}^{2}$$

where, Cov(Xₛ) is the covariance matrix of the source domain; Cov(Xₜ) is the covariance matrix of the target domain; and ∥·∥_{F} is a Frobenius norm, used for measuring difference between covariance matrices.
an expression for the correlation alignment loss function is:

$${L}_{CORAL} = \frac{1}{{d}^{2}} {‖ Cov ( {X}_{S} ) - Cov ( {X}_{t} ) ‖}_{F}^{2}$$

where, d is a dimension of feature space.

By minimizing the correlation alignment loss function, it is possible to align the covariance matrices of the source domain and target domain, making internal correlations more consistent.

Introducing a correlation alignment method based on the joint maximum mean difference, further reducing local distribution differences between the source domain and the target domain through covariance matrices alignment. The joint maximum mean difference adopts a kernel mean embedding method to compare feature distributions of the source domain and the target domain as a whole, and jointly match edge distribution and conditional distribution to adjust global statistical characteristics of the entire feature space. In contrast, correlation alignment aligns the covariance matrices to make the internal correlations of features in different domains more consistent, emphasizing a matching of local feature relationships.
s53: using a joint maximum mean difference loss function, correlation alignment loss function, and source domain classification loss function to jointly form a total loss function, and performing reverse updating on the transfer learning model;
an expression for the total loss function is:

$${L}_{total} = {L}_{CE} + {λ}_{JMMD} {L}_{JMMD} + {λ}_{CORAL} {L}_{CORAL}$$

where, L_{JMMD} is a JMMD loss between the source domain and the target domain; L_{CORAL} is a CORAL loss between the source domain and the target domain; L_{CE} is a cross entropy loss in source domain classification, wherein an expression of L_{CE} is:

$${L}_{CE} = - \frac{1}{n} {\sum }_{i = 1}^{{n}_{s}} {\sum }_{c = 1}^{C} {y}_{s}^{( i , c )} log ( {\hat{y}}_{s}^{( i , c )} )$$

where, λ_{JMMD} is a hyper-parameter used to adjust weights of each loss items in the joint maximum mean difference, λ_{CORAL} is a hyper-parameter used to adjust weights of each loss items in the correlation alignment, nₛ is a number of samples in the source domain, Cis a total number of classification categories.

$${y}_{s}^{( i , c )}$$

is a true label of the i-th sample in the source domain on class c, which is usually represented by one hot encoding; and

$${\hat{y}}_{s}^{( i , c )}$$

is a prediction probability of the i-th sample in the source domain on class c by the transfer learning model, which is usually output by an softmax function.
therefore, an expression for the total loss function is:

$${L}_{total} = - \frac{1}{{n}_{s}} {\sum }_{i = 1}^{{n}_{s}} {\sum }_{c = 1}^{C} {y}_{s}^{( i , c )} log ( {\hat{y}}_{s}^{( i , c} ) + {L}_{JMMD} {‖ {E}_{{x}_{s} ∼ {D}_{s}} [ k ( {x}_{s} , \cdot ) ] - {E}_{{x}_{t} ∼ {D}_{t}} [ k ( {x}_{c} , \cdot ) ] ‖}_{ℋ}^{2} + {λ}_{C O R A L} {‖ Cov ( {X}_{S} ) - Cov ( {X}_{t} ) ‖}_{F}^{2}$$

an optimization process of the total loss function will simultaneously consider source domain classification task and distribution alignment between the source domain and the target domain (through joint maximum mean difference and correlation alignment metrics), then achieving better cross domain transfer learning and classification performance.

Training the transfer learning model through the total loss function to achieve reverse updating of the transfer learning model.
s6: using the transfer learning model obtained in s5 to achieve fault diagnosis under secure transmission conditions of industrial data;
inputting the preprocessed data into the transfer learning model through the transmission method in s4 to achieve secure supervision and fault diagnosis of industrial data.

### Embodiment 2

The present embodiment provides a fault diagnosis method for secure transmission of industrial data based on transfer learning. The method is implemented based on the transfer learning model provided in embodiment 1, and data of a cement roller press is supervised and diagnosed through the method. Where the method specifically includes:
s1: data collection and storage; collecting historical data of two cement roller presses at different locations in a cement plant. Collecting data by installing four stress wave sensors SNR-10800, and using a data acquisition instrument for data storage and processing, and then upload the data to a server.
s2: data processing; firstly, cleaning and formatting the data. Subsequently segmenting first 1300 k points of each working condition of the two roller presses with a sliding step of 1024 based on 3072 sampling points as one data sample, after generating 1000 samples for each working condition, a cutoff is reached. Roller press A generates 4000 samples as a training set, while roller press B generates 4000 samples as another test set, for a total of 8000 samples.
s3: ensuring a secure transmission of data; using encryption algorithms and deploying IDS components to achieve trusted transmission of data by operation. Roller press A, as a data provider, uploading labeled source domain data, while roller press B, as a data consumer, transmitting unlabeled target domain data. The data of both roller press is aggregated to the same server through a data connector.
s4: using the transfer learning model to learn and train the data uploaded to the server, generating diagnostic results, and parsing the unlabeled data of roller press B to diagnose an actual operating status. According to the diagnostic results, an abnormal state of roller press B equipment is adjusted in a timely manner, thereby improving operational efficiency and stability of a production line.

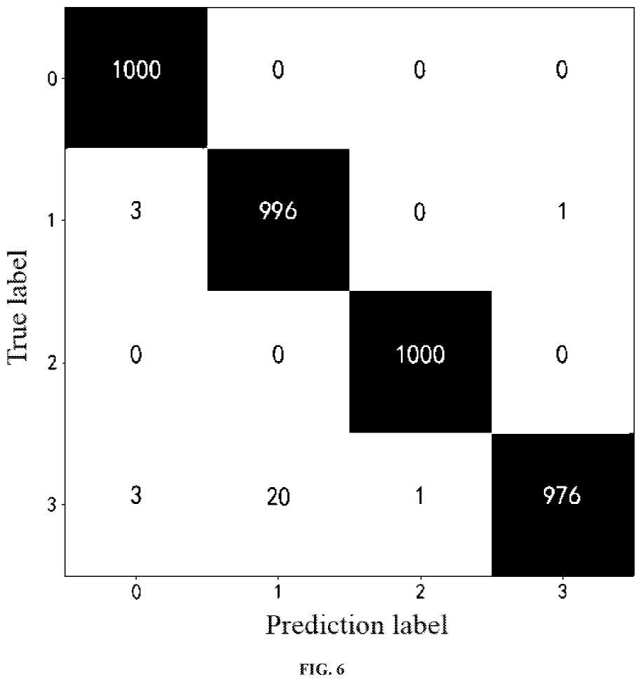

A confusion matrix of the classification results is shown in FIG. 6. It can be seen that there is some confusion between the sample data of predicted label 1 and predicted label 3, and most of samples with prediction errors are confused in condition 0 and condition 1. However, the vast majority of samples are concentrated on diagonal, that is majority of samples are correctly classified with an accuracy rate of 99.3%. Therefore, it can be proved that the transfer learning model proposed in the present disclosure has good effectiveness in identifying fault types in unlabeled target domains.

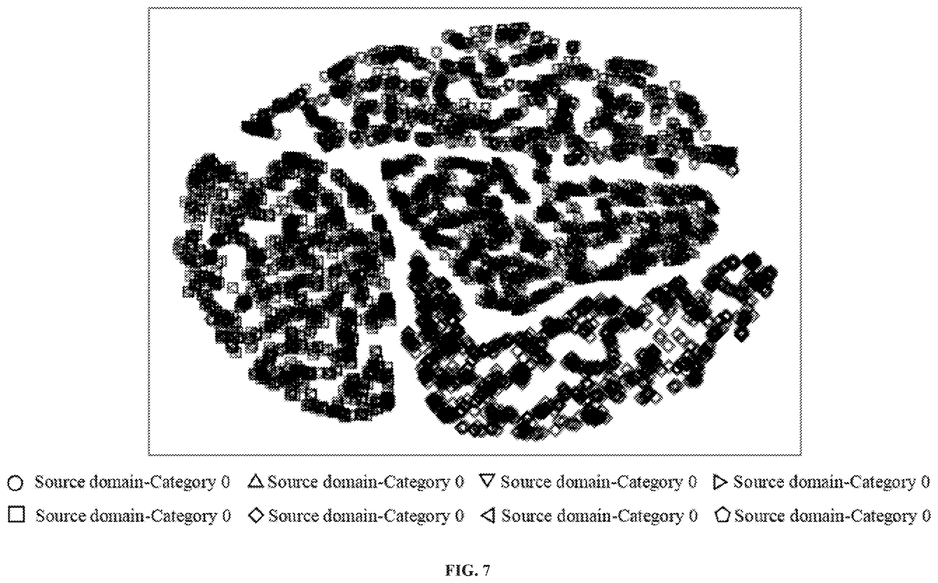

To verify effectiveness of the method proposed in the present disclosure, a t-SNE method was used to reduce dimensionality of feature data, and a scatter plot of the classification results is drawn, as shown in FIG. 7. Where category 0 represents dynamic roller heavy load, category 1 represents dynamic roller light load, category 2 represents fixed roller heavy load, and category 3 represents fixed roller light load. As shown in FIG. 7, feature points of each operating condition exhibit a relatively clear distribution in a dimensionality reduction space, with clear discrimination between different categories and no obvious mixing phenomenon. This indicates that the model can effectively extract and identify feature patterns under various operating conditions. The feature points exhibit strong clustering characteristics in a projection space, with clear boundaries, further demonstrating superiority of the transfer learning model proposed in this present disclosure in terms of generalization and robustness, and possessing good fault type identification ability.

Some steps in the embodiments of the present disclosure can be implemented using software, and corresponding software programs can be stored in readable storage media such as CDs or hard drives.

The above description is only a preferred embodiment of the present disclosure and is not intended to limit the present disclosure. Any modifications, equivalent substitutions, improvements, etc. made within the spirit and principles of the present disclosure should be included in a scope of protection of the present disclosure.

What is claimed is:

1. A fault diagnosis method for secure transmission of industrial data based on transfer learning, comprising:
s1: collecting raw data from different sources in industrial processes and classifying different types of data into different levels based on importance of the raw data;
s2: constructing a data storage module by defining an ontology model and mapping the raw data from s1 to the ontology model to obtain mapped data;
s3: preprocessing the mapped data in s2 to obtain preprocessed data;
s4: encrypting and transmitting the preprocessed data in s3 to obtain encrypted transmission data;
s5: constructing a transfer learning model and inputting the encrypted transmission data in s4 into the transfer learning model for training to obtain a trained transfer learning model; and
s6: using the trained transfer learning model obtained in s5 to achieve fault diagnosis under secure transmission conditions of industrial data;
wherein the transfer learning model in s5 comprises: a feature extraction module, a domain adaptation module, and a diagnostic classification module; wherein s5 comprises:
s51: constructing the feature extraction module for feature extraction of the encrypted transmission data, weighting through a Convolutional Block Attention Module (CBAM) hybrid attention mechanism to splice feature maps in a channel dimension, and finally outputting classification results;
s52: constructing the domain adaptation module, wherein cross domain feature distributions at global and local levels are measured by the domain adaptation module through joint maximum mean difference and correlation alignment;
s53: constructing a total loss function for performing reverse updating on the transfer learning model, wherein a joint maximum mean difference loss function, a correlation alignment loss function, and a source domain classification loss function jointly form the total loss function;
wherein the domain adaptation module comprises: the joint maximum mean difference and the correlation alignment, and wherein alignment of the cross domain feature distributions at global and local levels is achieved through the joint maximum mean difference and the correlation alignment;
wherein in s52, a processing procedure of the domain adaptation module comprises:
the joint maximum mean difference adjusts global statistical characteristics and local feature relationships of source and target domains through jointly matching edge distributions and conditional distributions; wherein an expression is:
$${JMMD}^{2} ( {D}_{s} , {D}_{t} ) = {‖ {E}_{{x}_{s} ∼ {D}_{s}} [ k ( {x}_{s} , \cdot ) ] - {E}_{{x}_{t} ∼ {D}_{t}} [ k ( {x}_{t} , \cdot ) ] ‖}_{ℋ}^{2}$$
wherein Dₛ is a data distribution of a source domain, which represents a distribution of labeled data used during model training; Dₜ is a data distribution of target domain, which represents a distribution of unlabeled data that the transfer learning model needs to adapt to; Eₓ_{ₛ}_{~D}_{ₛ} is an expectation of all samples xₛ in Dₛ, that is, a statistical average of source domain data; Eₓ_{ₜ}_{~D}_{ₜ} is an expectation of all samples x, in Dₜ, that is, a statistical average of target domain data; ∥·∥ is a norm; k(xₛ,·) is a kernel function; and [symbol] is a reproducing kernel Hilbert space;
wherein the correlation alignment is achieved by aligning a covariance matrix of features of the source domain and a covariance matrix of features of the target domain; assuming that a data feature of the source domain is X_{S}∈Rⁿ^{ₛ}^{×d} and a data feature of the target domain is Xₜ∈Rⁿ^{ₜ}^{×d}, an interdomain alignment is achieved by minimizing a difference between the covariance matrix of the source domain and the covariance matrix of the target domain, wherein an expression is:
$$CORAL ( {X}_{S} , {X}_{t} ) = {‖ Cov ( {X}_{S} ) - Cov ( {X}_{t} ) ‖}_{F}^{2}$$
wherein, Cov(Xₛ) is the covariance matrix of the source domain; Cov(Xₜ) is the covariance matrix of the target domain; and ∥·∥_{F} is a Frobenius norm, used for measuring difference between covariance matrices.

2. The fault diagnosis method for secure transmission of industrial data based on transfer learning according to claim 1, wherein the feature extraction module comprises: convolutional layers, max pooling layers, residual blocks, multi-scale concatenation layers, fusion convolutional layers, adaptive pooling layers, fully connected layers, and the CBAM hybrid attention mechanism,
wherein in s5, a processing procedure of the feature extraction module comprises:
the encrypted transmission data is passed through a 1×7 convolutional layer and a 2×2 max pooling layer to extract basic features, and the basic features are input into three multi-scale convolutional sub blocks for processing; wherein, each multi-scale convolutional sub block contains two cascaded residual blocks, wherein a size of convolutional kernel of a first multi-scale convolutional sub block is 1×3, a size of convolutional kernel of a second multi-scale convolutional sub block is 1×5, and a size of convolutional kernel of a third multi-scale convolutional sub block is 1×7; wherein in each multi-scale convolutional sub block, a number of input channels in first residual block is 64, a number of output channels in first residual block is 64; a number of input channels in second residual block is 64, and a number of output channels in second residual block is 128; wherein the basic features are weighted using the CBAM hybrid attention mechanism, and a number of feature-output channels of each multi-scale convolutional sub block is 128; wherein after global mean pooling, three features of different scales are concatenated together in a channel dimension to form a 1×1 feature map with 384 channels, the 1×1 feature map is input to the fully connected layers and processed to output the classification results.

3. The fault diagnosis method for secure transmission of industrial data based on transfer learning according to claim 1, wherein an expression for the joint maximum mean difference loss function in s53 is:
$${L}_{JMMD} = \frac{1}{{n}_{s}^{2}} {\sum }_{i , j = 1}^{{n}_{s}} k ( {x}_{s}^{i} , {x}_{s}^{j} ) + \frac{1}{{n}_{t}^{2}} {\sum }_{i , j = 1}^{{n}_{t}} k ( {x}_{t}^{i} , {x}_{t}^{j} ) - \frac{2}{{n}_{s} {n}_{t}} {\sum }_{i = 1}^{{n}_{s}} {\sum }_{j = 1}^{{n}_{t}} k ( {x}_{s}^{i} , {x}_{t}^{j} )$$
wherein, k is a kernel function, used to measure a similarity between two samples; nₛ is a number of samples in the source domain, that is a total number of samples extracted from D_{S};
$${x}_{s}^{i}$$
is an i-th sample in the source domain,
$${x}_{s}^{j}$$
is a j-th sample in the source domain, wherein i, j∈{1, 2, . . . , nₛ}; nₜ is a number of samples in the target domain, wherein
$${x}_{t}^{i}$$
is an i-th sample in the target domain,
$${x}_{t}^{j}$$
is a j-th sample in the target domain, wherein i, j∈{1, 2, . . . , nₜ};
an expression for the correlation alignment loss function is:
$${L}_{CORAL} = \frac{1}{{d}^{2}} {‖ Cov ( {X}_{S} ) - Cov ( {X}_{t} ) ‖}_{F}^{2}$$
wherein, d is a dimension of feature space; Cov(Xₛ) is the covariance matrix of the source domain; Cov(Xₜ) is the covariance matrix of the target domain; and ∥·∥_{F} is the Frobenius norm;
an expression for the total loss function is:
$${L}_{total} = {L}_{CE} + {λ}_{JMMD} {L}_{JMMD} + {λ}_{CORAL} {L}_{CORAL}$$
wherein, L_{JMMD} is a Joint Maximum Mean Discrepancy (JMMD) loss between the source domain and the target domain; L_{CORAL} is a Correlation Alignment (CORAL) loss between the source domain and the target domain; and L_{CE} is a cross entropy loss in source domain classification, wherein an expression of L_{CE} is:
$${L}_{C E} = - \frac{1}{n} {\sum }_{i = 1}^{{n}_{s}} {\sum }_{c = 1}^{C} {y}_{s}^{( i , c )} log ( {\hat{y}}_{s}^{( i , c )} )$$
wherein, λ_{JMMD} is a hyper-parameter used to adjust weights of each loss items in the joint maximum mean difference, λ_{CORAL} is a hyper-parameter used to adjust weights of each loss items in the correlation alignment, C is a total number of classification categories,
$${y}_{s}^{( i , c )}$$
is a true label of the i-th sample in the source domain on class c; and
$${\hat{y}}_{s}^{( i , c )}$$
is a prediction probability or the i-th sample in the source domain on class c by the transfer learning model;
therefore, an expression for the total loss function is:
$${L}_{total} = - \frac{1}{{n}_{s}} {\sum }_{i = 1}^{{n}_{s}} {\sum }_{c = 1}^{C} {y}_{s}^{( i , c )} log ( {\hat{y}}_{s}^{( i , c )} ) + {L}_{JMMD} {‖ {E}_{{x}_{s} ∼ {D}_{s}} [ k ( {x}_{s} , \cdot ) ] - {E}_{{x}_{t} ∼ {D}_{t}} [ k ( {x}_{t} , \cdot ) ] ‖}_{ℋ}^{2} + {λ}_{C O R A L} {‖ Cov ( {X}_{S} ) - Cov ( {X}_{t} ) ‖}_{F}^{2}$$
the transfer learning model is updated using the total loss function Lₜₒₜₐₗ; and
when the total loss function does not decrease during a training process, training of the transfer learning model ends.

4. The fault diagnosis method for secure transmission of industrial data based on transfer learning according to claim 1, wherein s2 comprises:
s21: describing the ontology model through a define of devices and operations through Web Ontology Language (OWL), constructing the data storage module using the ontology model, and representing semantics of the raw data in Resource Description Framework (RDF) format;
s22: designing an original database and storing the raw data in a standard table structure; and
s23: mapping the standard table structure and the raw data to the ontology model in s21 through D2RQ to achieve data storage.

5. The fault diagnosis method for secure transmission of industrial data based on transfer learning according to claim 1, wherein s4 comprises:
s41: encrypting data to be transmitted using Data Encryption Standard (DES) encryption technology;
s42: implementing secure transmission protocols and establishing encrypted channels through an industrial data space framework;
wherein the industrial data space framework comprises: a data security supervision platform, a first data connector, a second data connector, and a data sink, wherein the data security supervision platform comprises: an application store and a broker; the first data connector and the second data connector are responsible for providing standardized connection and usage control for the data security supervision platform, allowing trusted applications to be executed in an isolated and authenticated environment; the application store in the data security supervision platform has functions of basic data provision, data service and management, vocabulary management, and software monitoring; the broker is responsible for providing functions of management, search, data exchange protocols, and data exchange monitoring for data sources; data providers control an access and use of data by data consumers, allowing the data consumers to access data under specific purposes and models; data consumers search data from different data providers through brokers and use the data after establishing security protocols with the data providers; the data sink is responsible for receiving data from the data sources and converts the data into a format suitable for further processing;
s43: ensuring a security of data by signing data security protocols by the data providers with the data consumers;
s44: encrypting data during transmission using the DES encryption technology;
s45: providing a standardized framework for data exchange through the industrial data space framework, ensuring data providers have control over the data; and
s46: ensuring data security by setting access control and permission management;
wherein the data security protocols comprise one of Secure Sockets Layer/Transport Layer Security (SSL/TLS), IP Security (IPSec), Pretty Good Privacy (PGP), and Secure/Multipurpose Internet Mail Extensions (S/MIME).

6. The fault diagnosis method for secure transmission of industrial data based on transfer learning according to claim 1, wherein s3 comprises:
s31: data cleaning: processing noise in data through wavelet transform or Fourier transform, filling missing values through interpolation, detecting and processing outliers through Z-score or Inter Quartile Range (IQR) methods;
s32: data formatting processing: converting data from different sources into a unified standard format through standardization or normalization; and
s33: converting data formats to ensure compatibility between different systems.
